(19) United States
(12) Patent Application Publication
(10) Pub. No.: US 2011/0218039 A1
(43) Pub. Date: Sep. 8, 2011

(54) METHOD FOR GENERATING AN EFFECT SCRIPT CORRESPONDING TO A GAME PLAY EVENT

(75) Inventors: David A. Eves, Crawley (GB); Richard S. Cole, Redhill (GB)

(73) Assignee: AMBX UK LIMITED, Redhill, Surrey (GB)

(21) Appl. No.: 12/676,538

(22) PCT Filed: Sep. 1, 2008
(86) PCT No.: PCT/IB2008/053535

§ 371 Date: Dec. 2, 2010

(30) Foreign Application Priority Data
Sep. 7, 2007 (EP) 07115941.2

(51) Int. Cl. A63F 13/00

(52) U.S. Cl. 463/30

(57) ABSTRACT

An apparatus (100) arranged to generate an effect script and a method for generating an effect script corresponding to a game play event provided by a video game program comprising a game engine is described in which a game engine interface is used to code the game play event in graphical data for display on a screen by adjusting a value of at least one parameter of the game engine. A predefined region (310) of a displayed screen (300) corresponding to said graphical data is captured and decoded to obtain a retrieved game play event that corresponds to the game play event, and an effect script corresponding to the retrieved game play event is determined. The effect script is provided to the effects devices (12, 14, 16, 112) to render ambient effects related to the game play event.

### FIELD OF THE INVENTION

The invention relates to a method according to the preamble of claim 1. The invention further relates to a program code on a carrier which, when loaded into a computer and executed by a processor causes the processor to carry out the steps of the method. The invention further relates to an apparatus according to the preamble of claim 9 and a real world representation system comprising said apparatus.

### BACKGROUND OF THE INVENTION

When playing a video game on a personal computer or a game console, the user's experience of the video game consists, in most cases, of the viewing of a simple display device while listening to the associated audio. Since the advent of video games, it has been desired to augment this user experience. A number of ways of achieving this have been proposed, including head mounted displays, surround screen installations and game peripherals such as rumble pads. The object of these functional improvements has been to increase the user's immersion in the virtual game world.

International Patent Application Publication WO 02/092183 describes a real world representation system and language in which a set of devices are operated according to a received real world description, and hence render a “real world” experience in the ambient environment of the user. The real-world description is in the form of an instruction set of a markup language that communicates a description of physical environments and the objects within them, their relationship to the user, each other, and to the physical space of the user's ambient environment. For example, the real world experience may be rendered by effects devices such as lighting devices that project colored light onto the walls of the user's private dwelling, fan devices that simulate wind within the dwelling, or “rumble” devices that are embedded into the user's furniture to cause the user to feel vibrations. Hence an ambient immersive environment is created, which is flexible, scalable and provides an enhanced experience to a user.

To effectively augment the user's experience of the video game, the effects devices such as lighting devices, fan devices, rumble devices etc. generate the real world effects that together create a real world experience. These real world effects must be in close synchronicity with game play events happening in the virtual game world. For example, if a lightening flash occurs in the virtual game world, the flash should immediately be reflected by the effects devices (e.g. by pulsing a light-producing device). Hence changes in the virtual game world must be reflected by immediate changes in the effect scripts that are generated to operate the effects devices.

The aforementioned real world representation systems usually involve a scripting language interpreted by middleware, which then relays the appropriate commands to the effects devices through device drivers or a hardware abstraction layer (HAL) for example. Such systems require a high level descriptive script or ambient script that is associated with the virtual game world, and game play events therein, to be “built into” the virtual game world. For example, the user's character in the virtual video game world may be standing in a forest on a summers evening, and so an ambient script comprising the real-world description might read <FOREST>, <SUMMER>, <EVENING>. This real-world description may be interpreted into specific instructions or effect scripts for rendering effects devices in the user's ambient environment, such as to give a color tone of a pleasant green and a light level of low but warm, thereby rendering a ‘real world’ experience in the ambient environment.

In essence, the ambient script comprising the real world description must be incorporated at the time of authoring in the source code for the video game. Such direct authoring enables sophisticated and synchronized effects, according to the authors' creative view on the mood and feeling that should be projected, to occur at particular points or game play events within the video game.

In practice access to the source code of a commercial video game may not be possible. An addition of an ambient script to a video game requires involvement of game developers and publishers and may not be commercially attractive for video games that were already released.

It is therefore a disadvantage that for video games that were not authored together with an ambient script with known method no ambient immersive environment can be created, as there are no effect scripts to operate and control the effects devices.

### SUMMARY OF THE INVENTION

It is therefore an object of the invention to obtain effect scripts for video games that were not authored together with an ambient script.

This object is achieved with the method for generating an effect script corresponding to a game play event according to the characterizing portion of claim 1.

In the invention the game engine is used to code the game play event in the graphical data for display on a screen. As the game engine determines the look of the video game displayed graphical data may be adjusted using the game engine interface. After capturing the graphical data comprising the coded game play event and decoding it a retrieved game play event is obtained. This retrieved game play event matches the game play event that was coded in the graphical data. Next an effect script corresponding to said retrieved game play event is determined. Thus for a video game that was not authored together with an ambient script an effect script corresponding to the game play event is obtained, thereby achieving the object of the invention.

A game engine is a tool that allows a video game designer to easily code a video game without building the video game from the ground up. A new video game may be built using an already published game engine. Such a new game is called a ‘mod’ and may be a modification of an existing video game. The amount of modification can range from only changing the ‘looks’ of the video game to changing the game rules and thereby changing the ‘feel’. The game engine provides different functionalities such as the graphics rendering and has a game engine interface to access those functionalities.

A video game is played on a personal computer or a video game console such as for example the XBOX or Playstation. The personal computer and game console have a central processing unit or CPU that executes the video game code and a graphics processing unit or GPU that is responsible for generating the graphical data that is displayed on a screen, such as for example a LCD screen. By using the game engine comprised in the video game the graphical data that is displayed on the screen is modified.

An example of a video game is a first person shooter game commonly known as FPS. FPSs emphasize shooting and combat from the perspective of a character controlled by the player of the video game. In the video game events referred to as game play events will develop in response to user interaction. In the example of an FPS a game play event ‘explosion’ may result from a gun fired by the player of the video game. In an other example the character that is controlled by the player of the video game may decide to leave a building and run through a forest resulting in the game play event to develop from ‘dark room’ to ‘forest’.

In general by playing the video game a plurality of game play events will be provided. By using the game engine interface the game play events are coded in graphical data for display on a screen. As a result of the coding of the game play events in the graphical data for display on a screen at least one pixel in a screen image that is to be displayed will be changed. In a further embodiment of the method the coding of the game play event in graphical data for display on a screen results in adjusting the color value of a pixel or a group of pixels. By coding the game play event the color value of some pixels in the predefined region of the displayed screen image may change. In the example of the FPS the game play events ‘explosion’, ‘dark room’ and ‘forest’ may be coded in graphical data for display on a screen resulting in a color adjustment of three pixels, but may be even coded resulting in a color adjustment of only one pixel, as this one pixel may have a plurality of color values and each color value may code a game play event. It is advantageously that the coding may not be noticeable for a player of the video game as the color values of just a few pixels are adjusted as a result of the coding of the game play events in graphical data.

In an other embodiment of the method a game play event is coded by adjusting the color of a predetermined pattern of pixels in a predefined region of a screen. As an example the game play event ‘forest’ may be coded with a plurality of pixels that together make up a small icon of a tree in the lower right corner of the screen. In this example the user (or player) of the video game may notice the appearance of the icon as soon as the character enters the forest.

It is advantageously to use only a predefined region of the displayed screen image for coding as this reduces the decoding effort. In the example of the icon in the lower right corner of the screen not all captured graphical data relating to the displayed screen image needs to be decoded but only the graphical data relating to the predefined region in the lower right corner of the screen.

The decoding of the graphical data may involve pattern recognition. In a further embodiment of the method the decoding may be realized relatively simple by determining the dominant color value of said predefined region as for example the dominant color of the icon of a small tree may be green enabling the detection of a pattern corresponding to a tree.

The determining of the effect script corresponding to the retrieved game play event may be realized by consulting a database having for a plurality of game play events a matching ambient script. The ambient script comprising a real-world description may be interpreted into specific instructions or effect scripts for rendering effects devices in the user's ambient environment. Or in a further embodiment the database may comprise the effect scripts, each game play event having a corresponding effect script. With an effects device receiving the effect script the user's experience of a video game that was not authored together with an ambient script may be augmented. Therefore in a further embodiment of the method the determined effect script corresponding to the retrieved game play event is provided to an effects device. The effects device interprets the effect script and generates in response thereto at least one real world effect in close synchronicity with the game play event in the virtual game world.

In the examples given the game play events are visible in the graphical data that is displayed on a screen. The explosion resulting from gunfire will be visible on the screen. The position of the explosion may however be related to the position of the object at which the character is aiming, and this object may be ‘anywhere’. With the method according to the invention the game play event ‘explosion’ can be coded to be at a known position in the screen making the decoding step relatively simple.

Game play events are not necessarily visible in the graphical data that is displayed on the screen. In the example of a FPS a monster may approach the user's character from behind. As long as the character does not turn or look over his shoulder nothing may change in the graphical data that is displayed, however there is a game play event ‘monster approaching’. The game engine interface also offers a look into what is happening in the virtual game world of the video game and may be used to detect the game play event ‘monster approaching’. This provides even further opportunities to make an immersive ambient environment. Therefore in a further embodiment the method comprises prior to the step of coding the game play event a further step of detecting said game play event.

The effects device receives an effect script from an apparatus that is arranged to generate the effects script. In an embodiment the apparatus is adapted to code a game play event in graphical data for display, capture the graphical data in a buffer memory, decode the captured graphic data to obtain a retrieved game play event, and determine the effect script corresponding to the retrieved game play event. The apparatus has the advantage that even with a video game that has no associated authored ambient script an immersive ambient environment can be created which provides an enhanced experience to the user. An example of such an apparatus is a game console that has been adapted for providing an effect script to an effects device.

With the apparatus and an effects device a real world representation system is obtained. With said system the user is able to ‘upgrade’ his experience of the video game.

Further optional features will be apparent from the following description and accompanying claims. Embodiments of the invention will now be described, by way of example only, with reference to the accompanying drawings.

### BRIEF DESCRIPTION OF THE DRAWINGS

In the drawings:

FIG. 1 shows schematically a real world representation system,

FIG. 2 illustrates a method for generating an effect script according to the invention,

FIG. 3 shows a displayed screen image,

FIG. 4 shows schematically an apparatus arranged to generate an effect script according to the invention.

### DETAILED DESCRIPTION OF THE EMBODIMENTS

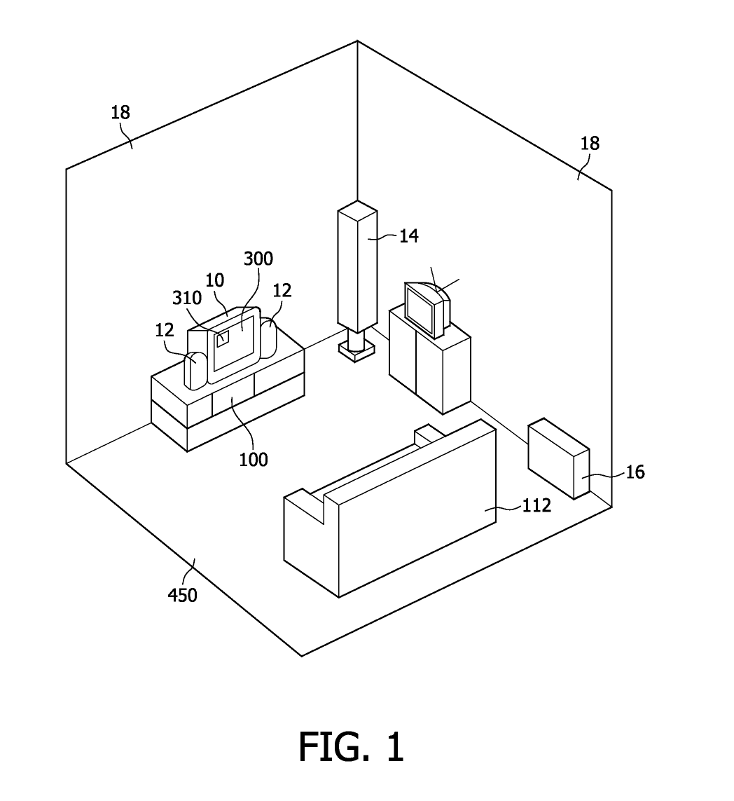

FIG. 1 illustrates an embodiment of a real world representation system 450 that comprises a computer or game console 100 with display device 10 and a set of effects devices 12, 14, 16, 112 including for example, audio speakers 12, a lighting device 14, a heating or cooling (fan) device 16 and a rumbling device 112 that is arranged to shake the couch. An effects device may provide more than one real world effect. Each speaker 12 in the system of FIG. 1 for example may also include a lighting device for coloring the wall behind the display device 10. The effects devices may be electronic or they may be purely mechanical. The effects devices are interconnected by either a wireless network or a wired network such as a powerline carrier network. The computer or game console 100 in this embodiment of the real world representation system 450 enables video gaming and the set of effects devices 12, 14, 16, 112 augment a virtual game world provided by the video game by adding real world effects such as for example light, sound, heat or cold, wind, vibration, etc.

to the displayed screen images 300 that are in close synchronicity with the game play events in the virtual game world.

At least one of the effects devices 12, 14, 16, 112 making up the real world representation system 450 is arranged to receive an effect script in the form of an instruction set of a mark-up language (although other forms of script may also be employed by the skilled person) and the effects devices 12, 14, 16, 112 are operated according to said effect script. In this example, the effect script cause the effects devices to augment the experience of a video game that a user is playing on the computer or game console 100.

When the code of the video game being executed by the computer or game console 100 does not have effects scripts embedded in its video game program no real world effects from the effects devices 12, 14, 16, 112 will be generated in response to game play events that result from a user interacting with the video game (or playing the video game). However, with the method for generating an effect script corresponding to a game play event real world effects may be generated in the room 18, even when no effect script has been embedded in the video game program.

As previously discussed a new video game may be built using an already published game engine. Such a new game is called a “mod” and is basically a modification of an existing video game. The amount of modification can range from only changing the clip size of a weapon in a first person perspective shooter, to creating completely new video game assets and changing the video game genre. A game engine is a complex set of modules that offers a coherent interface to the different functionalities that comprise the graphics rendering. Despite the specificity of the name the game engine may be the core software component of interactive applications such as for example architectural visualizations training simulations. Typically the interactive application has real-time graphics. Thus in this description the term ‘video game’ should be interpret as ‘interactive application’, and the term ‘game engine’ as the core software component in such an interactive application.

The game engine has a game engine interface, also referred to as “modding interface” allowing access to a plurality of parameters through which functionality of the video game can be changed. By adjusting at least one of these parameters the ‘look and feel’ of the video game is changed. The “modding interface” also offers a look into what is happening in the video game as it provides access to a value of attributes. As an example the game engine may provide access to an attribute ‘time of day’ wherein a value of ‘time of day’ is providing information on whether it is night or day in the virtual game world. By playing the video game and in dependence of the execution of the game engine the value of the attribute ‘time of day’ may change from ‘day’ to ‘night’.

With some of the available video games the “modding interface” allows open access to other programs and devices attached to the computer or game console 100, however many of the video games for a variety of commercial and practical reasons only operate within tightly constrained boundaries. This is known as a “Sandbox” approach. In the “Sandbox” it is allowed to play around, and change the ‘look and feel’ of the video game. The ‘look’ of the video game relates to the items that are displayed on the screen: for example by changing the clip size of a weapon in a first person perspective shooter the ‘look’ of the video game is changed. It is also possible to change the rules of the video game, thereby changing the ‘feel’. It is however not possible to change I/O interfacing of the game engine to create a new access to other programs. This will prevent, complicate or limit the ability to control effects devices 12, 14, 16, 112 that are coupled to the computer or game console 100 to create real world effects in synchronicity with game play events that are happening in the virtual game world.

In the invention it is recognized that it is possible to make “a hole in the Sandbox”. Since it is possible to change the ‘look’ of the video game it is possible to add information in the graphical data that is displayed on a screen image. Next the added information may be captured from the screen image, or from a memory buffer storing the graphical data that relates to the screen image. Thus information may be passed on from the video game program to a further program using the ability to change with the ‘modding interface’ the ‘look’ of the video game. Next, the further program may control an effects device 12, 14, 16, 112 in response to the information that is passed on from the video game program.

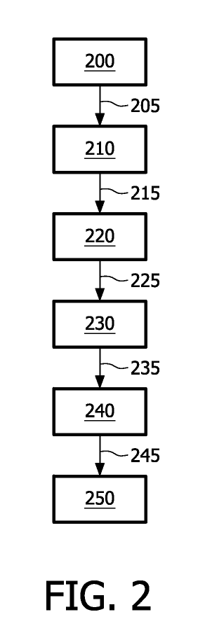

FIG. 2 illustrates a method to make ‘the hole in the Sandbox’. An interactive application such as for example a program code of a video game is loaded into the computer or game console 100. The display 10 is coupled to the computer 100 and arranged to show a screen image. The screen image is dependent on the graphical data, which on its turn is dependent on the execution of the game engine. By using the game engine interface or “modding interface” access is provided to a plurality of parameters of the game engine.

A code of a further program that is loaded into the computer or game console 100 may together with the code of the video game program result in an adjustment of a value of a parameter thereby coding 210 a game play event 205 in graphical data. In the example of the game play event ‘explosion’ resulting from gunfire in the FPS video game the graphical data that is displayed shows an ‘explosion’ on a certain position on the screen image. The position of the explosion on the screen image may however be related to the position of the object at which the character is aiming, and this object may be ‘anywhere’. By adjusting the value of the parameter the game play event 205 ‘explosion’ is coded 210 in graphical data resulting in a coded version of the game play event ‘explosion’ to be at a predetermined position on the screen image.

An execution of a code of the further program that is also loaded into the computer or game console 100 results in capturing 220 of the graphical data 215 relating to said screen image and comprising the coded game play event. The execution of the code further results in decoding 230 of the captured graphical data 225 comprising the ‘coded’ game play event to obtain a retrieved game play event 235, wherein the retrieved game play event 235 corresponds to the game play event 205 that was initially coded. Next an effect script 245 relating to the retrieved game play event 235 is determined 240. Thus information on a game play event may be passed on from the video game program to the further program using the ability to change with the ‘modding interface’ the ‘look’ of the video game. Next, the further program may be used to control with the determined effect script 245 an effects device 12, 14, 16, 112.

Thus with the “hole in the Sandbox” a method for generating an effect script 245 corresponding to a game play event 205 is enabled. The method comprises the steps of

coding 210 a game play event 205 in graphical data for display on a screen using a game engine interface, the game engine interface being comprised in the video game providing the game play event,

capturing 220 the graphical data 215 comprising the coded game play event,

decoding 230 the captured graphic data to obtain a retrieved game play event 235 corresponding to the game play event 205,

determining 240 the effect script 245 corresponding to the retrieved game play 235 event.

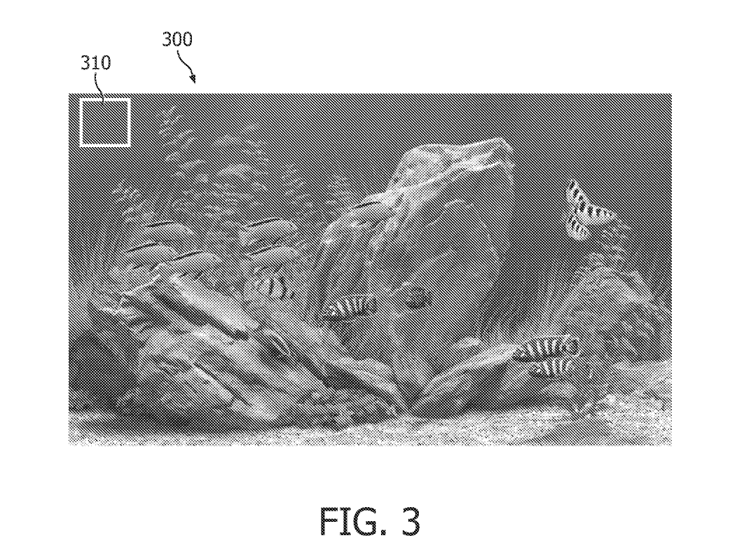

FIG. 3 schematically illustrates a screen image 300 displayed by the display device 10 wherein said screen image 300 results from graphical data for display on a screen. A program code of a video game comprising a game engine is loaded into the computer or game console 100. A further program code provided on a carrier such as a memory card or an optical disk, or downloaded from a server using the Internet is loaded into the computer or game console 100. The carrier and the Internet may also provide the video game together with the further program code. The further program code is executed on a processor comprised in the computer or game console 100 and causes a value of at least one parameter of the game engine to be adjusted using the game engine interface and causes further the graphic data comprising the coded game play event and relating to the screen image 300 to be captured before display in a memory of the computer or game console 100 using known graphical techniques, such as video frame interception for example. Subsequently an analysis algorithm comprised in the further program code analyzes the graphical data comprising the coded game play event and relating to the captured screen image 300 to obtain a retrieved game play event 235, which then directs the selection of an appropriate effects script 245. In the example of FIG. 3 the video game provides a screen image 300 with an underwater scene. A parameter of the game engine is adjusted such that in a predefined region 310 of a displayed screen image 300 a game play event 205 relating to the underwater scene is ‘coded’ by changing a value of the parameter. The graphical data relating to the predefined region 310 of the screen image 300 is captured 220 and decoded 230.

An example of decoding 230 of the captured graphic data to obtain the retrieved game play event 235 is the application of a predefined rule on the captured graphical data 225. The predefined rule in this example comprises the step of determining whether the average color value of the pixels in the predefined region 310 falls in a certain range of values. If TRUE, then the game play event “TROPICAL SEA” is obtained.

Next the determining 240 of the effect script 245 corresponding to said retrieved game play event “TROPICAL SEA” comprises the step of determining the ambient script corresponding to the retrieved game play event 235 “TROPICAL SEA”. The ambient script may be retrieved from a database or lookup table that is included in the code of the further program. Next the ambient script corresponding to the retrieved game play event 235 “TROPICAL SEA” is interpreted by middleware comprised in the further program code resulting in an effect script 245. In a next step of the method for generating an effect script 245 corresponding to a game play event 205 the determined effect script 245 is provided to at least one effects device 12, 14, 16, 112 to render tropical sea real world effects such as for example blue light and a bubbling sound.

In an other embodiment the ambient script or effect script may be retrieved from a server using the internet providing the advantage that the ambient scripts or effect script may be easily updated.

As previously discussed in the example of FIG. 3 by using the game engine interface a value of at least one parameter of the game engine is adjusted thereby coding 210 a game play event 205 relating to the underwater scene in the graphical data for display on a screen. In an embodiment of the method for generating an effect script 245 the coding 210 of the game play event 205 in graphical data results in an adjustment of the color or luminance of at least one pixel in a displayed screen image 300. It is preferred that the adjustment of the color or luminance of at least one pixel in the displayed screen image 300 does not disturb a user playing the video game, and therefore a predefined region 310 at an edge of the displayed screen image 300 may be used. A further advantage of using the predefined region 310 is that the decoding 230 of the graphical data comprising the coded game play event 235 to obtain the retrieved game play event involves a subset of the graphical data, that is the subset relating to said predefined region 310, thereby reducing a decoding effort to obtain the retrieved game play event corresponding to the game play event 205.

In a further embodiment of the method for generating an effect script 245 a value of at least one parameter of the game engine is adjusted by using the game engine interface thereby coding a game play event 205 in graphical data resulting in an adjustment of the color or luminance of a predetermined pattern of pixels in a displayed screen image 300. An advantage of this embodiment is that more means are provided to code 210 a game play event 205. A further advantage is that the coding 210 of the game play event 205 may also deliberately be done in such a way that it results in an item or symbol in the displayed screen image 300 that is observable by the user (or player) of the video game. As an example the coding of a game play event 205 ‘summer day’ may result in a yellow sun in the right top corner of the displayed screen image 300 to be visible. When it becomes ‘evening’ in the virtual game world the position of the sun may be adjusted thereby coding the game play event ‘summer evening’. Consequently the decoding 230 of the graphical data 215 comprising the coded game play event to obtain the retrieved game play 235 event comprises capturing 220 the graphical data of the predefined region 310 of the displayed screen image 300, determining the position of the predetermined pattern of pixels, i.e. in the example given the position of the sun, and using the determined position to determine the retrieved game play event 235, in the example given ‘summer day’ or ‘summer evening’.

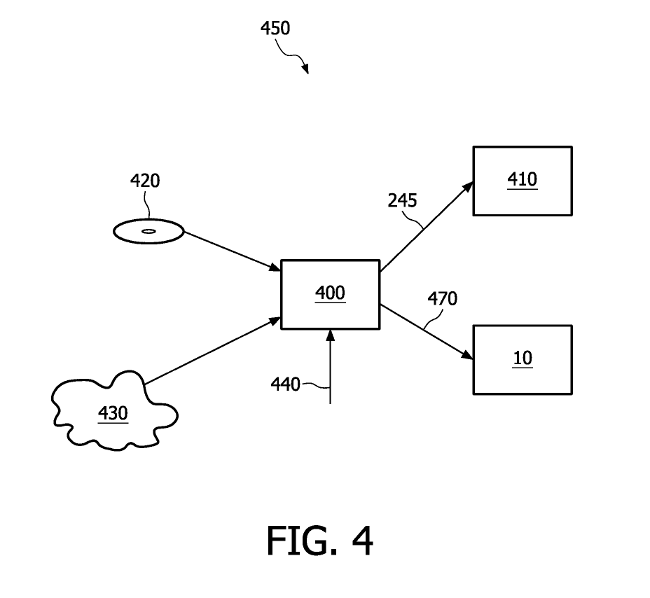

FIG. 4 illustrates a real world representation system 450 comprising an apparatus 400 such as for example a computer or a game console that is adapted to generate an effect script 245. The effect script 245 is provided to an effects device 410, also comprised in the real world representation system 450 and the effects device 410 is operated in dependence of said effect script. Examples of effects devices are audio speakers 12, a lighting device 14, a heating or cooling (fan) device 16 and a rumbling device 112. The effects devices augment a user's experience of a game play event, said game play event being dependent on the execution of a video game program that is stored in a memory which is comprised in the apparatus, the video game program being executed on a processor also comprised in the apparatus 400. A user interacting with the video game provides input 440 to the apparatus 400. This input 440 may be given using a keyboard, mouse, joystick or the like. The apparatus 400 may have display means or may be connected to a display 10 such as for example a LCD screen. The apparatus 400 further comprises communication means to provide a determined effect script to the effects device 410 and comprises further communication means to exchange data using the internet 430. The apparatus may further comprise data exchange means such as for example a DVD drive, CD drive or USB connector to provide access to a data carrier 420. The video program may be down loaded from the internet 430 or retrieved from the data carrier 420 such as for example a DVD. The apparatus 400 is adapted to code a game play event in graphical data for display 470, capture the graphical data in a buffer memory, decode the captured graphical data to obtain a retrieved game play event corresponding to the game play event and determine the effect script corresponding to the retrieved game play event. The effect script may be retrieved from the internet 430, but may also be included in the video game program. The effect script 235 controls the effects device 410 resulting in an augmentation of the user's experience of said game play event.

1. A method for generating an effect script corresponding to a game play event, the method in comprising:
(A) coding a game play event in graphical data for display on a screen using a game engine interface, the game engine interface being comprised in the video game providing the game play event,
(B) capturing the graphical data comprising the coded game play event,
(C) decoding the captured graphical data to obtain a retrieved game play event said retrieved game play event corresponding to the game play event, and
(D) determining the effect script corresponding to the retrieved game play event.

2. A method according to claim 1 further comprising,
(X) detecting said game play event prior to (A).

3. A method according to claim 1 wherein (A) comprises:
(A1) adjusting the color of a plurality of pixels in a predefined region of a displayed screen image to a predetermined value, said displayed screen image being dependent on the graphical data for display on a screen.

4. A method according to claim 3 wherein (C) comprises:
(C1) capturing the graphical data of the predefined region of the displayed screen image,
(C2) determining a dominant color value, and
(C3) using the determined dominant color value to determine the retrieved game play event.

5. A method according to claim 1 wherein (A) the step of comprises:
(A1) adjusting the color of a predetermined pattern of pixels in a predefined region of a displayed screen image, said displayed screen image being dependent on the graphical data for display on a screen.

6. A method according to claim 5 wherein (C) comprises:
(C1) capturing the graphical data of the predefined region of the displayed screen image,
(C2) determining the position of the predetermined pattern of pixels, and
(C3) using the determined position to determine the retrieved game play event.

7. A method according to claim 1 further comprising:
(E) providing the determined effect script corresponding to the retrieved game play event to an effects device.

8. Program code on a carrier which, when loaded into a computer and executed by a processor in the computer causes the processor to carry out the method of claim 1.

9. An apparatus arranged to generate an effect script, said effect script being arranged to operate an effects device to augment a user's experience of a game play event, the apparatus comprising:
(A) a memory arranged to store a video game program,
(B) a processor arranged to execute the video game program, the game play event being dependent on the execution of the video game program, and
(C) a communication mechanism arranged to provide a determined effect script to the effects device,
the apparatus being adapted to generate an effect script, said effect script being arranged to operate an effects device to augment a user's experience of a game play event.

10. The apparatus according to claim 9 in combination with at least one effects device.

11. The apparatus according to claim 9 further configured to code a game play event in graphical data for display, and further configured to capture, in a memory, the graphical data comprising the coded game play event.

12. The apparatus according to claim 11 further configured to decode the captured graphical data to obtain a retrieved game play event corresponding to said game play event.

13. The apparatus according to claim 12 further configured to determine the effect script corresponding to the retrieved game play event.

14. A computer program product for use with an apparatus configured for generating an effect script corresponding to a game play event, the computer program product comprising a computer readable storage medium having program code embodied thereon, the program code comprising:
(A) program code for coding a game play event in graphical data for display on a screen using a game engine interface, the game engine interface being comprised in the video game providing the game play event,
(B) program code for capturing the graphical data comprising the coded game play event,
(C) program code for decoding the captured graphical data to obtain a retrieved game play event, said retrieved game play event corresponding to the game play event, and
(D) program code for determining the effect script corresponding to the retrieved game play event.

15. A method according to claim 14 further comprising:
(X) program code for detecting said game play event prior to (A).

16. A method according to claim 14 wherein (A) comprises:
(A1) program code for adjusting the color of a plurality of pixels in a predefined region of a displayed screen image to a predetermined value, said displayed screen image being dependent on the graphical data for display on a screen.

17. A method according to claim 16 wherein (C) comprises:
(C1) program code for capturing the graphical data of the predefined region of the displayed screen image,
(C2) program code for determining a dominant color value, and
(C3) program code for using the determined dominant color value to determine the retrieved game play event.

18. A method according to claim 14 wherein (A) comprises:
(A1) program code for adjusting the color of a predetermined pattern of pixels in a predefined region of a displayed screen image said displayed screen image being dependent on the graphical data for display on a screen.

19. A method according to claim 18 wherein (C) comprises:
(C1) program code for capturing the graphical data of the predefined region of the displayed screen image,
(C2) program code for determining the position of the predetermined pattern of pixels, and
(C3) program code for using the determined position to determine the retrieved game play event.

20. A method according to claim 1 further comprising:
(E) program code for providing the determined effect script corresponding to the retrieved game play event to an effects device.
